(19) United States
(12) Patent Application Publication
(10) Pub. No.: US 2025/0018430 A1
(43) Pub. Date: Jan. 16, 2025

(54) Gold Panning Device

(71) Applicant: Kenneth Owens, Auburn, CA (US)

(72) Inventor: Kenneth Owens, Auburn, CA (US)

(21) Appl. No.: 18/768,098

(22) Filed: Jul. 10, 2024

Related U.S. Application Data
(60) Provisional application No. 63/512,758, filed on Jul. 10, 2023.

(51) Int. Cl. B07B 1/22; B07B 1/42

(52) U.S. Cl. CPC B07B 1/22; B07B 1/42

(57) ABSTRACT

A gold panning device is disclosed which comprises a multipurpose gold panning system. The gold panning device comprises a tumbler with several internal rows with cutout teeth for breaking up raw materials. The tumbler barrow features a quarter inch screen with a loading chute in the back and a handle in the front. The internal cutout teeth can be used to break up the materials as they pass through the device. The device is also comprised of a feeding tray and a turning handle. Thus, the gold can be retrieved from the separated materials with ease. The device is square in shape with a round tumbler inside the housing and contains four wheels and a handle for easy transportation while panning for gold.

### CROSS-REFERENCE TO RELATED APPLICATION

The present application claims priority to, and the benefit of, U.S. Provisional Application No. 63/512,758, which was filed on Jul. 10, 2023, and is incorporated herein by reference in its entirety.

### FIELD OF THE INVENTION

The present invention relates generally to the field of gold panning devices. More specifically, the present invention relates to a multipurpose gold panning device that is capable of breaking up sand, dirt, clay and rock to easily separate gold from other debris. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in gold panning devices. Generally, panning for gold and other materials can be a difficult and time-consuming task. People may need to use multiple tools like screens, box shakers, etc., to sift through different debris looking for valuable items. Cleaning materials instead of processing gold can be frustrating.

Hand-held gold pans have been used for many years for separating gold particles from alluvial material. Depending on the experience of the person gold panning, the process can be slow and some of the gold particles can easily be lost in the process. Sluice boxes have also been used for many years which speed up the process but are generally bulky and heavy and can lose a significant percentage of the gold.

Accordingly, there is a demand for an improved gold panning device that saves considerable time and effort when panning for gold. More particularly, there is a demand for a gold panning device that is capable of breaking up and sand, dirt, clay, and rock to easily separate gold from other debris.

Therefore, there exists a long felt need in the art for a gold panning device that provides users with a gold panning system capable of breaking up sand, dirt, clay, and rock to easily separate gold from other debris. There is also a long felt need in the art for a gold panning device that includes multiple internal rows of cutout teeth that can break up raw materials as they are placed in the device. Further, there is a long felt need in the art for a gold panning device that saves considerable time and effort when panning for gold, producing more material to make clean soil for gardening and planting. Moreover, there is a long felt need in the art for a gold panning device that improves the quality of material used in other applications like gardening and planting. Further, there is a long felt need in the art for a gold panning device that features a loading shoot in the back and a handle in the front. Finally, there is a long felt need in the art for a gold panning device that allows for only one tool to be used instead of multiple while panning for gold.

The subject matter disclosed and claimed herein, in one embodiment thereof, comprises a gold panning device. The device is a multipurpose gold panning device. The gold panning device comprises a tumbler with several internal rows with cutout teeth for breaking up raw materials. The tumbler barrow features a quarter inch screen with a loading chute in the back and a handle in the front. The internal cutout teeth can be used to break up the materials as they pass through the device. The device is also comprised of a feeding tray and a turning handle. Thus, the gold can be retrieved from the separated materials with ease. The device is square in shape with a round tumbler inside the housing and contains four wheels and a handle for easy transportation while panning for gold.

In this manner, the gold panning device of the present invention accomplishes all of the forgoing objectives and provides users with a gold panning system capable of breaking up sand, dirt, clay, and rock to easily separate gold from other debris. The device is a tumbler with several internal rows of cutout teeth. The device can comprise a plurality of wheels and a handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gold panning device. The device is a multipurpose gold panning device. The gold panning device comprises a tumbler with several internal rows with cutout teeth for breaking up raw materials. The tumbler barrow features a loading chute in the back and a handle in the front. The internal cutout teeth can be used to break up the materials as they pass through the device. Thus, the gold can be retrieved from the separated materials with case. Further, the device is square in shape with a round tumbler inside the housing and contains four wheels and a handle for easy transportation while panning for gold.

In one embodiment, the gold panning device is a multipurpose gold panning device for separating heavy metals and precious stones from alluvial material, such as sand, dirt, clay, rock, etc. The broken up and separated materials can then be used for gardening, planting, or other suitable applications. Thus, the device saves considerable time and effort when panning for gold and produces more viable material to make clean soil for gardening and planting. Accordingly, the device improves the quality of material used in other applications, such as gardening and planting, etc.

In one embodiment, the gold panning device comprises a frame component that is configured in a rectangular or square shape but can be any suitable shape as is known in the art. The frame component comprises an open top and bottom, opposing side walls, and opposing front and back walls. Typically, the frame component comprises four wheels secured to the corners of the open bottom via any suitable securing means. The wheels can be any suitable size and allow the device to be easily transported.

In one embodiment, the back wall of the frame component comprises a handle. The handle can be any suitable shape and size as is known in the art. The handle is typically bolted, screwed, or welded to the frame component for use. The handle can comprise a textured surface for an ergonomical grip.

In one embodiment, the interior of the frame component houses a tumbler barrow. The tumbler barrow is configured in a cylindrical shape and rotates about an interior shaft. The exterior of the tumbler barrow is comprised of a mesh screening, with a closed end and an open end. Typically, the mesh screening comprises quarter inch openings to allow the separated materials to pass through. The openings of the mesh screening can be any suitable shape and size as is known in the art. The tumbler barrow rests within the frame component on the ends of the interior shaft, allowing the tumbler barrow to rotate within the frame component. Further, the interior shaft of the tumbler barrow comprises multiple rows of cutout teeth. The multiple rows of cutout teeth act to break up and separate the material fed into the device. The multiple rows of cutout teeth are secured to the interior shaft via bolts, screws or welding. The rows of cutout teeth extend down from the interior shaft but do not contact the interior surface of the tumbler barrow.

In one embodiment, the outside of the tumbler barrow comprises a hand crank secured to the closed end. The hand crank is axially secured to the tumbler barrow via bolts, screws, or welding. The hand crank would be any suitable shape and size as is known in the art, as long as the hand crank allows a user to easily grasp and rotate the hand crank. Furthermore, rotation of the hand crank causes rotation of the tumbler barrow. Rotation of the tumbler barrow drags the multiple rows of cutout teeth through the material, which breaks apart and separates the material as it passes through the device. The separated material then passes through the openings of the tumbler barrow and out of the device. Gold can then be retrieved from the separated materials with ease.

In one embodiment, the frame component comprises a feeding tray component secured to the open end of the tumbler barrow via any suitable securing means. The feeding tray component is shaped as a loading chute to allow a user to load materials into the tumbler barrow. A user would pour material to be separated directly into the feeding tray component, which would then enter the interior of the tumbler barrow.

In one embodiment, the frame component comprises a utility basket near the handle. The utility basket can be any shape and size and is used to store tools or other devices, as needed. The utility basket is typically a wire basket but can be suitable configuration as is known in the art.

In one embodiment, the tumbler barrow comprises a door or other suitable opening where users can tip the classifier back on its back wheels, turn the cage, and it will empty the contents itself.

In use, the gold panning device separates gold from the other materials. A user pours material to be separated into the feeding tray of the device. Once the material is poured into the feeding tray, it passes into the open end of the tumbler barrow and into the interior of the tumbler barrow. Then, a user turns the hand crank which rotates the tumbler barrow and causes the material to move within the tumbler barrow. As the tumbler barrow turns, the material is dragged through the rows of cutout teeth and separated. The separated material then passes out of the mesh screen openings of the tumbler barrow. Thus, gold can easily be retrieved from the separated material and used for other applications, such as gardening, planting, etc. Further, the handle and wheels allow for the device to be transported to wherever the gold panning will occur and a utility basket is used to hold any tools necessary for the project.

It will be further appreciated that this device is described as being used for isolation of gold, but it may be used just as well for isolation of any other precious metals or stones such as platinum, diamonds etc.

In yet another embodiment, the gold panning device comprises a plurality of indicia.

In yet another embodiment, a method of easily panning for gold is disclosed. The method includes the steps of providing a gold panning device with the feeding tray and turning handle. The method also comprises filling the feeding tray with material to be sifted through for gold. Further, the method comprises turning the handle to allow for the material to go through the device. The method also comprises collecting the gold that has been separated from the material. Finally, the method comprises using the left-over material for gardening, planting, or other applications.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the gold panning device of the present invention showing the inside cavity of the device in accordance with the disclosed architecture;

FIG. 2 illustrates a perspective view of one embodiment of the gold panning device of the present invention showing the feeding tray and the turning handle in accordance with the disclosed architecture;

FIG. 3 illustrates a perspective view of one embodiment of gold panning device of the present invention showing the bottom of the device and the plurality of wheels in accordance with the disclosed architecture;

FIG. 4 illustrates a perspective view of one embodiment of the gold panning device of the present invention showing the device in use in accordance with the disclosed architecture;

FIG. 5 illustrates a perspective view of one embodiment of the gold panning device of the present invention showing the dimensions of the device in accordance with the disclosed architecture; and

FIG. 6 illustrates a flowchart showing the method of easily panning for gold in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a gold panning device that provides users with a gold panning system capable of breaking up sand, dirt, clay, and rock to easily separate gold from other debris. There is also a long felt need in the art for a gold panning device that includes multiple internal rows of cutout teeth that can break up raw materials as they are placed in the device. Further, there is a long felt need in the art for a gold panning device that saves considerable time and effort when panning for gold, producing more material to make clean soil for gardening and planting. Moreover, there is a long felt need in the art for a gold panning device that improves the quality of material used in other applications like gardening and planting. Further, there is a long felt need in the art for a gold panning device that features a loading shoot in the back and a handle in the front. Finally, there is a long felt need in the art for a gold panning device that allows for only one tool to be used instead of multiple while panning for gold.

The present invention, in one exemplary embodiment, is a novel gold panning device. The gold panning device comprises a tumbler with several internal rows with cutout teeth for breaking up raw materials. The tumbler barrow features a quarter inch screen with a loading chute in the back and a handle in the front. The internal cutout teeth can be used to break up the materials as they pass through the device. The device is also comprised of a feeding tray and a turning handle. Thus, the gold can be retrieved from the separated materials with ease. The device is square in shape with a round tumbler inside the housing and contains four wheels and a handle for easy transportation while panning for gold. The present invention also includes a novel method of panning for gold. The method includes the steps of providing a gold panning device with the feeding tray and turning handle. The method also comprises filling the feeding tray with material to be sifted through for gold. Further, the method comprises turning the handle to allow for the material to go through the device. The method also comprises collecting the gold that has been separated from the material. Finally, the method comprises using the left-over material for gardening, planting, or other applications.

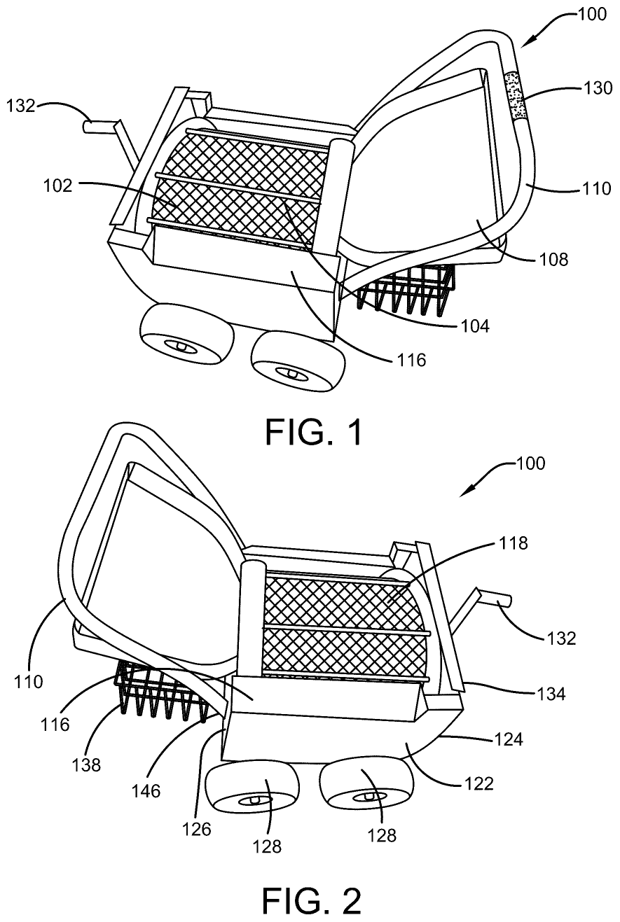

Referring initially to the drawings, FIG. 1 illustrates a perspective view of one embodiment of the gold panning device 100 of the present invention. In the present embodiment, the gold panning device 100 is an improved gold panning device 100 that provides a user with a means for breaking up sand, dirt, clay and rock to separate gold from other debris. Specifically, the gold panning device 100 comprises a tumbler barrow 102 with several internal rows of teeth 104 for breaking up raw materials 106. The tumbler barrow 102 features a loading chute 108 in the back and a handle 110 in the front. The internal cutout teeth 104 can be used to break up the materials 106 as they pass through the device 100. Thus, the gold 112 can be retrieved from the separated materials 114 with ease.

Generally, the gold panning device 100 is a multipurpose gold panning device for separating heavy metals and precious stones from alluvial material, such as sand, dirt, clay, rock, etc. The broken up and separated materials 114 can then be used for gardening, planting, or other suitable applications. Thus, the device 100 saves considerable time and effort when panning for gold 112 and produces more viable material to make clean soil for gardening and planting. Accordingly, the device 100 improves the quality of material used in other applications, such as gardening and planting, etc.

As shown in FIG. 2, the gold panning device 100 comprises a frame component 116 that is configured in a rectangular or square shape but can be any suitable shape as is known in the art. The frame component 116 comprises an open top 118 and bottom 120, opposing side walls 122, and opposing front 124 and back 126 walls. Typically, the frame component 116 comprises four wheels 128 secured to the corners of the open bottom 120 via any suitable securing means. The wheels 128 can be any suitable size and allow the device 100 to be easily transported.

The plurality of wheels 128 may be disposed on the underside of the frame component 116 and may allow the device 100 to roll in any direction. In other words, the plurality of wheels 128 may rotate, swivel, and pivot, based on a user's preference and/or commands. The plurality of wheels 128 can be secured to an underside of the frame component 116 via any suitable securing means as is known in the art, such as bolts, screws, pins, etc. Further, any suitable wheels 128 can be utilized as is known in the art, such as castors, rollers, swivel wheels, etc. In one embodiment, the plurality of wheels 128 are rugged, all-terrain wheels which help the device 100 travel around the yard during use.

Further, the back wall 126 of the frame component 116 comprises a handle 110. The handle 110 can be any suitable shape and size as is known in the art. The handle 110 is typically bolted, screwed, or welded to the frame component 116 for use. The handle 110 can comprise a textured surface 130 for an ergonomical grip.

Additionally, the outside of the tumbler barrow 102 comprises a hand crank 132 secured to a closed end 134. The hand crank 132 is axially secured to the tumbler barrow 102 via bolts, screws, or welding. The hand crank 132 would be any suitable shape and size as is known in the art, as long as the hand crank 132 allows a user to easily grasp and rotate the hand crank 132. Furthermore, rotation of the hand crank 132 causes rotation of the tumbler barrow 102. Rotation of the tumbler barrow 102 drags the multiple rows of cutout teeth 104 through the material 106, which breaks apart and separates the material 114 as it passes through the device 100. The separated material 114 then passes through openings 136 of the tumbler barrow 102 and out of the device 100. Gold 112 can then be retrieved from the separated materials 114 with case.

Furthermore, the frame component 116 comprises a utility basket 138 near the handle 110. The utility basket 138 can be any shape and size and is used to store tools or other devices, as needed. The utility basket 138 is typically a wire basket but can be suitable configuration as is known in the art.

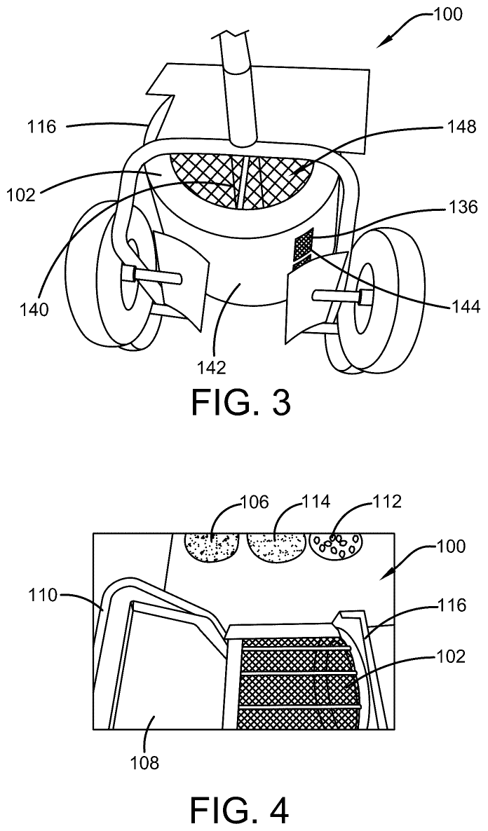

As shown in FIG. 3, the interior of the frame component 116 houses a tumbler barrow 102. The tumbler barrow 102 is configured in a cylindrical shape and rotates about an interior shaft 140. The exterior 142 of the tumbler barrow 102 is comprised of a mesh screening 144, with a closed end 134 and an open end 146. Typically, the mesh screening 144 comprises quarter inch openings 136 to allow the separated materials 114 to pass through. The openings 136 of the mesh screening 144 can be any suitable shape and size as is known in the art. The tumbler barrow 102 rests within the frame component 116 on the ends of the interior shaft 140, allowing the tumbler barrow 102 to rotate within the frame component 116. Further, the interior shaft 140 of the tumbler barrow 102 comprises multiple rows of cutout teeth 104. The multiple rows of cutout teeth 104 act to break up and separate the material 106 fed into the device 100. The multiple rows of cutout teeth 104 are secured to the interior shaft 140 via bolts, screws or welding. The rows of cutout teeth 104 extend down from the interior shaft 140 but do not contact the interior surface 148 of the tumbler barrow 102.

As shown in FIG. 4, the frame component 116 comprises a feeding tray component 108 secured to the open end 146 of the tumbler barrow 102 via any suitable securing means. The feeding tray component 108 is shaped as a loading chute to allow a user to load materials 106 into the tumbler barrow 102. A user would pour material 106 to be separated directly into the feeding tray component 108, which would then enter the interior 148 of the tumbler barrow 102.

In use, the gold panning device 100 separates gold 112 from the other materials. A user pours material 106 to be separated into the feeding tray 108 of the device 100. Once the material 106 is poured into the feeding tray 108, it passes into the open end 146 of the tumbler barrow 102 and into the interior 148 of the tumbler barrow 102. Then, a user turns the hand crank 132 which rotates the tumbler barrow 102 and causes the material 106 to move within the tumbler barrow 102. As the tumbler barrow 102 turns, the material 106 is dragged through the rows of cutout teeth 104 and separated. The separated material 114 then passes out of the mesh screen openings 136 of the tumbler barrow 102. Thus, gold 112 can easily be retrieved from the separated material 114 and used for other applications, such as gardening, planting, etc. Further, the handle 110 and wheels 128 allow for the device 100 to be transported to wherever the gold panning will occur and a utility basket 138 is used to hold any tools necessary for the project.

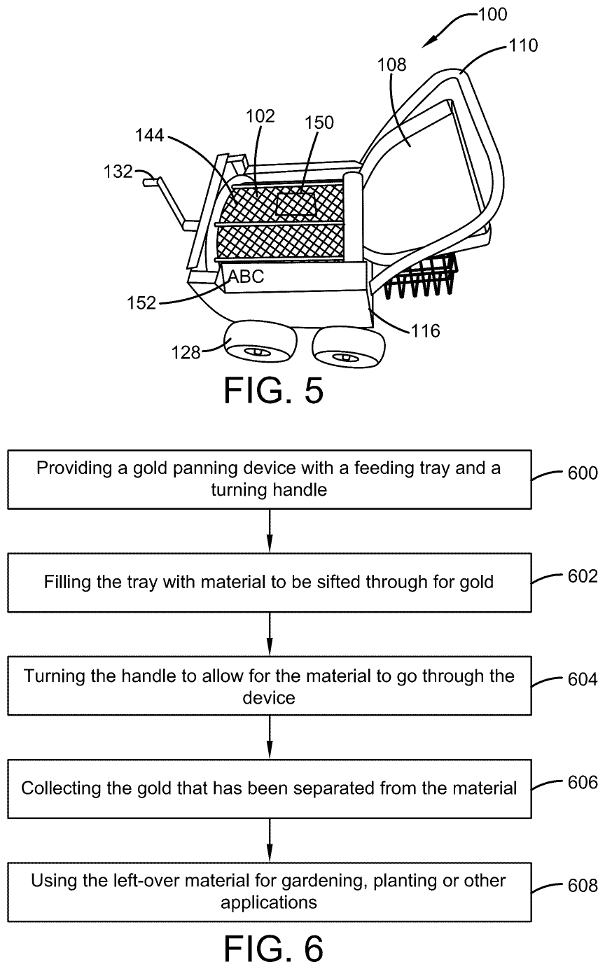

As shown in FIG. 5, in one embodiment, the tumbler barrow 102 comprises a door 150 or other suitable opening where users can reach in and empty the tumbler barrow contents after the material 114 has been separated.

It will be further appreciated that this device 100 is described as being used for isolation of gold 112, but it may be used just as well for isolation of any other precious metals or stones such as platinum, diamonds etc.

Further, the gold panning device 100 is manufactured from stainless steel, high carbon steel, aluminum, steel, or other suitable materials as is known in the art, or a combination of such materials.

In yet another embodiment, the gold panning device 100 comprises a plurality of indicia 152. The frame component 116 of the device 100 may include advertising, a trademark, or other letters, designs, or characters, printed, painted, stamped, or integrated into the frame component 116, or any other indicia 152 as is known in the art. Specifically, any suitable indicia 152 as is known in the art can be included, such as but not limited to, patterns, logos, emblems, images, symbols, designs, letters, words, characters, animals, advertisements, brands, etc., that may or may not be gold panning, filtering, or brand related.

FIG. 6 illustrates a flowchart of the method of easily panning for gold. The method includes the steps of at 600, providing a gold panning device with the feeding tray and turning handle. The method also comprises at 602, filling the feeding tray with material to be sifted through for gold. Further, the method comprises at 604, turning the handle to allow for the material to go through the device. The method also comprises at 606, collecting the gold that has been separated from the material. Finally, the method comprises at 608, using the left-over material for gardening, planting, or other applications.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “gold panning device”, “panning device”, and “device” are interchangeable and refer to the stool with gold panning device 100 of the present invention.

Notwithstanding the forgoing, the gold panning device 100 of the present invention can be of any suitable size and configuration as is known in the art without affecting the overall concept of the invention, provided that it accomplishes the above stated objectives. One of ordinary skill in the art will appreciate that the gold panning device 100 as shown in FIGS. 1-6 is for illustrative purposes only, and that many other sizes and shapes of the gold panning device 100 are well within the scope of the present disclosure. Although the dimensions of the gold panning device 100 are important design parameters for user convenience, the gold panning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gold panning device that provides a user with a means for separating gold from other debris, the gold panning device comprising:
a frame component;
a tumbler barrow with several internal rows of teeth; and
a hand crank;
wherein the tumbler barrow is housed within the frame component;
wherein raw materials are inserted into the tumbler barrow;
wherein users turn the hand crank to rotate the raw materials within the tumbler barrow; and
further wherein the several internal rows of teeth break up the raw materials within the tumbler barrow, allowing gold to be retrieved from separated materials with ease.

2. The gold panning device of claim 1, wherein the frame component is configured in a square shape, comprising an open top and bottom, opposing side walls, and opposing front and back walls.

3. The gold panning device of claim 2, wherein the frame component comprises four wheels secured to corners of the open bottom.

4. The gold panning device of claim 3, wherein the four wheels comprise castors, rollers, swivel wheels, or rugged, all-terrain wheels.

5. The gold panning device of claim 4, wherein the back wall of the frame component comprises a handle.

6. The gold panning device of claim 5, wherein the handle includes a textured surface for an ergonomical grip.

7. The gold panning device of claim 6, wherein the hand crank is axially secured to the tumbler barrow, such that rotation of the hand crank causes rotation of the tumbler barrow.

8. The gold panning device of claim 7, wherein the frame component comprises a utility basket near the handle.

9. The gold panning device of claim 8, wherein the tumbler barrow is configured in a cylindrical shape and rotates about an interior shaft.

10. The gold panning device of claim 9, wherein an exterior of the tumbler barrow is comprised of a mesh screening.

11. The gold panning device of claim 10, wherein the mesh screening comprises quarter inch openings to allow the separated materials to pass through.

12. The gold panning device of claim 11, wherein the several internal rows of teeth are secured to the interior shaft and extend down from the interior shaft but do not contact an interior surface of the tumbler barrow.

13. The gold panning device of claim 12, wherein the frame component comprises a feeding tray component secured to the tumbler barrow to allow a user to load materials into the tumbler barrow.

14. A gold panning device that provides a user with a means for separating gold from other debris, the gold panning device comprising:
a frame component configured in a square shape, comprising an open top and bottom, opposing side walls, and opposing front and back walls;
a tumbler barrow configured in a cylindrical shape, which rotates about an interior shaft that includes several internal rows of teeth; and
a hand crank axially secured to the tumbler barrow, such that rotation of the hand crank causes rotation of the tumbler barrow; and
wherein the tumbler barrow is housed within the frame component;
wherein the frame component comprises four wheels secured to corners of the open bottom;
wherein the back wall of the frame component comprises a handle;
wherein an exterior of the tumbler barrow is comprised of a mesh screening;
wherein the mesh screening comprises quarter inch openings to allow the separated materials to pass through;
wherein the several internal rows of teeth are secured to the interior shaft and extend down from the interior shaft but do not contact an interior surface of the tumbler barrow;
wherein raw materials are inserted into the tumbler barrow;
wherein users turn the hand crank to rotate the raw materials within the tumbler barrow; and
further wherein the several internal rows of teeth are dragged through the raw materials within the tumbler barrow, allowing gold to be retrieved from separated materials with ease.

15. The gold panning device of claim 14, wherein the frame component comprises a utility basket near the handle.

16. The gold panning device of claim 14, wherein the frame component comprises a feeding tray component secured to the tumbler barrow to allow a user to load materials into the tumbler barrow.

17. The gold panning device of claim 14, wherein the tumbler barrow comprises a door where users can reach in and empty the tumbler barrow contents after the raw materials have been separated.

18. The gold panning device of claim 14, wherein the gold panning device is manufactured from stainless steel, high carbon steel, or aluminum.

19. The gold panning device of claim 14 further comprising a plurality of indicia.

20. A method of easily panning for gold, the method comprising the following steps:
providing a gold panning device with the feeding tray and turning handle;
filling the feeding tray with material to be sifted through for gold;
turning the handle to allow for the material to go through the device;
collecting the gold that has been separated from the material; and
using the left-over material for gardening, planting, or other applications.
